(19) United States
(12) Patent Application Publication
(10) Pub. No.: US 2021/0234492 A1
(43) Pub. Date: Jul. 29, 2021

(54) OVERLOAD CONTROL IN A POWER TOOL

(71) Applicant: MILWAUKEE ELECTRIC TOOL CORPORATION, Brookfield, WI (US)

(72) Inventors: Brian Trump, Germantown, WI (US); David H. Selfors, Pewaukee, WI (US)

(21) Appl. No.: 17/051,216

(22) PCT Filed: Apr. 15, 2020
(86) PCT No.: PCT/US2020/028227

§ 371 Date: Oct. 28, 2020

Related U.S. Application Data
(60) Provisional application No. 62/835,299, filed on Apr. 17, 2019.

(51) Int. Cl. H02P 29/024; B25F 5/00; H02H 7/20; H02P 23/14

(52) U.S. Cl. CPC H02P 29/024; H02P 23/14; H02H 7/20; B25F 5/008

(57) ABSTRACT

Power tools including a housing, a motor, a power circuit supplying operating power to the motor through a triac, a speed sensor configured to detect a speed of the motor, a speed selector, and an electronic processor. The electronic processor is configured to determine a selected speed and set a present conduction angle of the triac to an initial conduction angle corresponding to the selected speed. The electronic processor is also configured to determine whether the speed is decreasing and determine whether the present conduction angle is below a maximum conduction angle corresponding to the selected speed when the speed is decreasing. The electronic processor is further configured to increase the present conduction angle when the present conduction angle is below the maximum conduction angle and maintain the present conduction angle at the maximum conduction angle when the present conduction angle is at or above the maximum conduction angle.

### RELATED APPLICATIONS

This application claims priority to U.S. Provisional Patent Application No. 62/835,299, filed on Apr. 17, 2019, the entire content of which is incorporated herein by reference.

### FIELD

Embodiments described herein relate to controlling an overload condition on a power tool.

### SUMMARY

In alternating current (AC) powered power tools, power may be provided to the motor through a triac. A conduction angle of the triac is varied to change the amount of power provided to the motor. During variable speed control of the power tool, a change in the load may result in an increase or decrease of the motor speed. For example, when the load on the motor increases, the speed of the motor may decrease. To compensate for this decrease in motor speed, the conduction angle of the triac may be increased to stabilize the speed.

At higher motor speeds, the airflow generated by a fan driven by the motor helps decrease or disperse the heat generated due to higher current flowing through the motor caused by an increase in load. Accordingly, the power tool can be operated for longer periods of time at high speeds even when the load on the power tool is increased. However, at lower motor speeds, the airflow generated by the fan may not be sufficient to decrease the heat generated due to higher current flowing through the motor caused by the increase in load. Heat may, therefore, build up more quickly during low speed, high load operation than during high speed, high load operation.

Power tools described herein include a housing, a motor within the housing, a power circuit supplying operating power to the motor through a triac, a speed sensor configured to detect a speed of the motor, a speed selector, and an electronic processor coupled to the motor, the triac, the speed sensor, and the speed selector. The electronic processor is configured to determine, from the speed selector, a selected speed and set a present conduction angle of the triac to an initial conduction angle corresponding to the selected speed. The electronic processor is also configured to determine whether the speed is decreasing and determine whether the present conduction angle is below a maximum conduction angle corresponding to the selected speed when the speed is decreasing. The electronic processor is further configured to increase the present conduction angle when the present conduction angle is below the maximum conduction angle corresponding to the selected speed and maintain the present conduction angle at the maximum conduction angle corresponding to the selected speed when the present conduction angle is at or above the maximum conduction angle.

Methods described herein provide for overload control of a power tool. The method includes determining, using an electronic processor, a selected speed and setting, using the electronic processor, a present conduction angle of a triac to an initial conduction angle corresponding to the selected speed. The method also includes determining, using the electronic processor, whether the speed is decreasing and determining, using the electronic processor whether the present conduction angle is below a maximum conduction angle corresponding to the selected speed when the speed is decreasing. The method further includes increasing, using the electronic processor, the present conduction angle when the present conduction angle is below the maximum conduction angle corresponding to the selected speed and maintaining, using the electronic processor, the present conduction angle at the maximum conduction angle corresponding to the selected speed when the present conduction angle is at or above the maximum conduction angle.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a perspective view of a power tool in accordance with some embodiments.

FIG. 2 illustrates a block diagram of the power tool of FIG. 1 in accordance with some embodiments.

FIG. 3 illustrates an example current waveform provided to a motor of the power tool of FIG. 1.

FIG. 4 is a graph illustrating a temperature condition of the power tool of FIG. 1.

FIG. 5 is a flowchart illustrating a method of overload control of the power tool of FIG. 1 in accordance with some embodiments.

FIG. 6 is a graph illustrating an effect of limiting the conduction angle in the power tool of FIG. 1 in accordance with some embodiments.

### DETAILED DESCRIPTION

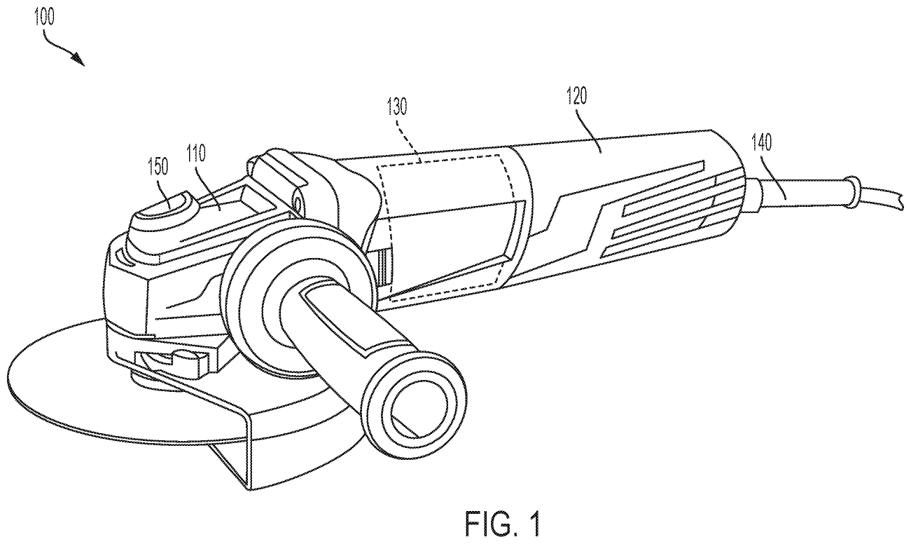

FIG. 1 illustrates an example power tool 100 in accordance with some embodiments. In the example illustrated, the power tool 100 is an alternating current (AC) grinder including a housing 110 having a handle portion 120 and a motor 130 provided within the housing 110. The motor is, for example, a brushless motor including stator coils that are selectively energized to drive a permanent magnet rotor. The power tool 100 receives operating power from a power cord 140. A speed selector 150 is provided on the housing 110 for selecting an operating speed of the power tool 100.

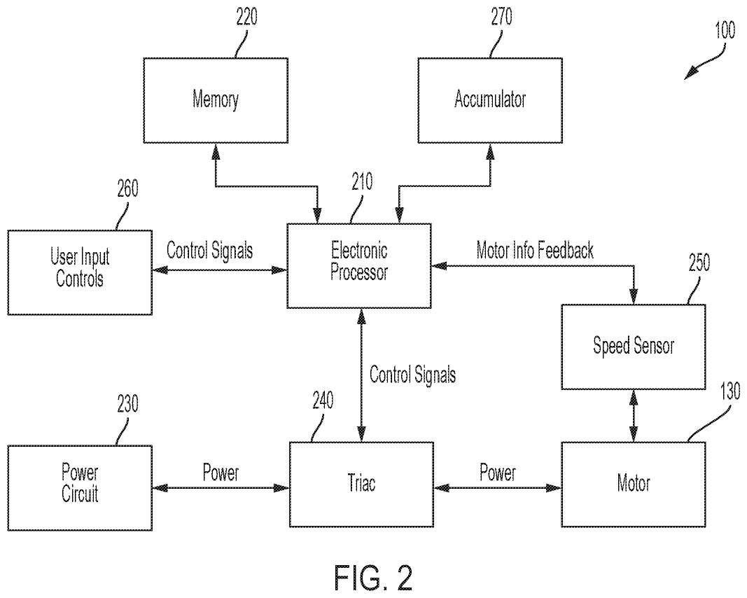

FIG. 2 illustrates a simplified block diagram of the power tool 100 in accordance with some embodiments. In the example illustrated, the power tool 100 includes an electronic processor 210, a memory 220, a power circuit 230 (for example, AC power from the power cord 140), a triac 240, the motor 130, a speed sensor 250, and user input controls 260. The memory 220 includes read only memory (ROM), random access memory (RAM), other non-transitory computer-readable media, or a combination thereof. The electronic processor 210 is configured to communicate with the memory 220 to store data and retrieve stored data. The electronic processor 210 is configured to receive instructions and data from the memory 220 and execute, among other things, the instructions. In particular, the electronic processor 210 executes instructions stored in the memory 220 to perform the methods described herein.

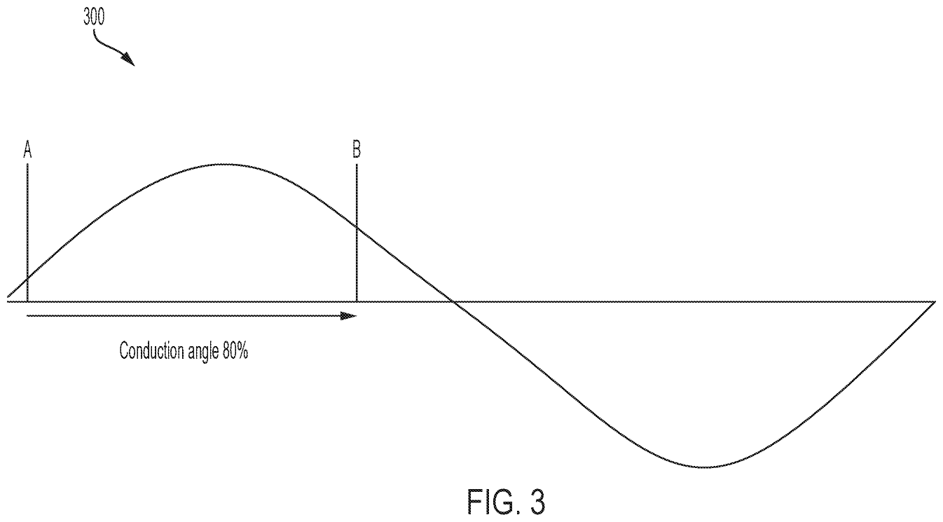

The power circuit 230 is configured to receive and supply, for example, AC power (e.g., 120V/60 Hz) received from a wall outlet through the power cord 140. Power from the power circuit 230 is provided to the motor 130 through the triac 240. The amount of power provided to the motor 130 is varied based on the conduction angle of the triac 240. Conduction angle may be represented as a percentage and denotes the percentage of available power provided to the motor 130 (e.g., the percentage that the triac 240 is enabled during one period or half period of the sinusoidal AC waveform). FIG. 3 illustrates an example current waveform 300 provided to the motor 130. In the example illustrated, the conduction angle of the triac 240 is set to 80%. The conduction angle is controlled by the electronic processor 210. Here, the electronic processor 210 enables the triac 240 at point A and disables the triac 240 at point B. The triac 240 conducts power from the power circuit 230 to the motor 130 when the triac 240 is enabled and cuts-off power from the power circuit 230 to the motor 130 when the triac 240 is disabled. The speed of the motor 130 can be varied by varying the conduction angle of the triac 240.

With reference again to FIG. 2, the speed sensor 250 outputs an indication of the motor speed. The speed sensor 250 is coupled to or associated with the motor 130 and the electronic processor 210. In some embodiments, the speed sensor 250 may include, for example, Hall-effect sensors, a rotary encoder, an inductive sensor, and the like. The speed sensor 250, in a Hall-effect sensor embodiment of the speed sensor 250, generates an output signal (e.g., a pulse) each time a magnet of the rotor rotates across the face of the sensor, which is positioned axially adjacent to the rotor. Based on the motor feedback information from the speed sensor 250, the electronic processor 210 can directly determine the position, speed (i.e., velocity), and acceleration of the rotor.

The user input controls 260 include, for example, the speed selector 150 and/or other actuators (e.g., variable speed trigger/paddle, power switch, etc.) to control the operation of the power tool 100. The electronic processor 210 receives user control signals from the user input controls 260, such as a depression of a trigger or power switch, a speed selection signal from the speed selector 150, and the like. In response to the motor feedback information and user controls, the electronic processor 210 transmits control signals to control the triac 240 to drive the motor 130. By controlling the conduction angle of the triac 240, power from the power circuit 230 is selectively applied to stator coils of the motor 130 to cause rotation of the rotor of the motor 130.

Although the power tool 100 illustrated in FIGS. 1 and 2 is an AC grinder, the present description applies also to other power tools having a motor such as, for example, an impacting wrench, a hammer drill, an impact hole saw, an impact driver, a drill, a reciprocating saw, and the like. The present description also applies to brushed and brushless motors and controls. The present description also applies to power tools that are powered with AC power as well as those power tools that are operated with direct current (DC) power (e.g., with a power tool battery pack).

For example, a DC power tool 100 may include a battery pack as the power circuit 230 that provides DC power to the motor 130. The triac 240 may be replaced with an inverter bridge including a plurality of field effect transistors (FETs) controlled by the electronic processor 210. The electronic processor 210 may control the FETs in response to the motor feedback signals from the speed sensor 250 and the user control signals from the user input controls 260. The electronic processor 210 controls a duty cycle of the pulse-width-modulated (PWM) signals provided to the FETs to control the motor 130. For example, an 80% duty cycle provides about 80% of the available power to the motor 130. For embodiments described herein, the description of the conduction angle and the limits applied thereto with respect to AC tools are similarly applied to the PWM duty cycle for embodiments including DC tools.

Returning to FIG. 2, the electronic processor 210 receives an input from the user input controls 260 indicating the speed selected by the speed selector 150. The electronic processor 210 sets an initial conduction angle of the triac 240 corresponding to the selected speed. The load on the motor 130 varies based on, among other factors, the toughness of the work-piece encountered by the tool bit of the power tool. As the load on the motor 130 increases, the speed of the motor 130 decreases due to the increased work needed to cut the work-piece. The electronic processor 210 monitors the speed on the motor 130 using the speed sensor 250. When the electronic processor 210 detects that the speed is decreasing, the electronic processor 210 increases the conduction angle of the triac 240 to maintain the selected speed. Similarly, when the load on the motor 130 subsequently decreases, the speed of the motor 130 increases past the selected speed. The electronic processor 210 detects the increase in speed and reduces the conduction angle of the triac 240 to maintain the selected speed.

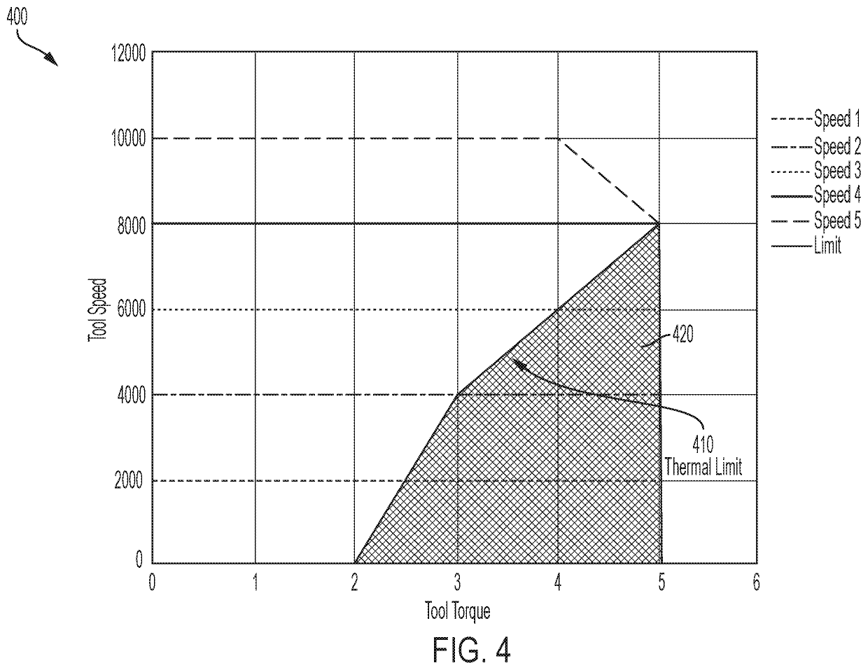

FIG. 4 is a graph 400 illustrating a temperature condition of the power tool 100. The graph 400 includes load on the X-axis and speed on the Y-axis. As can be seen from the graph 400, the speed is maintained constant even when the load is increased. Temperature curve 410 is a temperature limit of the power tool 100. Operating the power tool 100 in the area 420 shown under the temperature curve 410 for extended periods may result in damage of the electrical components of the power tool 100. Typically, the motor 130 is shut-off when the power tool 100 reaches the temperature limit indicated by the temperature curve 410. The power tool 100 includes a temperature sensor or temperature estimator that provides a temperature indication to the electronic processor 210. The electronic processor 210 turns off the motor 130 when the temperature indication indicates that the temperature is above a predetermined threshold.

The motor 130 includes a fan that is coupled to and rotates with the output shaft of the motor 130 and provides cooling airflow to the motor 130 and other components of the power tool 100. During high speed operation, the fan generates more airflow for reducing the heat in the motor 130 and the power tool 100. Accordingly, the motor 130 can be operated at high speeds for longer periods of time before the power tool 100 reaches the temperature limit, even when the load on the motor 130 is increasing. During low speed operation, the fan may not generate enough airflow to provide cooling to the motor 130 for extended operation of the motor 130. Accordingly, the motor 130 may be operated for shorter periods of time before the power tool 100 reaches the temperature limit when the load on the motor 130 is increasing.

As described above, the electronic processor 210 shuts off the motor 130 when the temperature reaches the temperature limit and keeps the motor 130 off until the temperature returns to below the temperature limit. However, this shutdown may be undesirable since the power tool 100 may not be used, resulting in slow down of work.

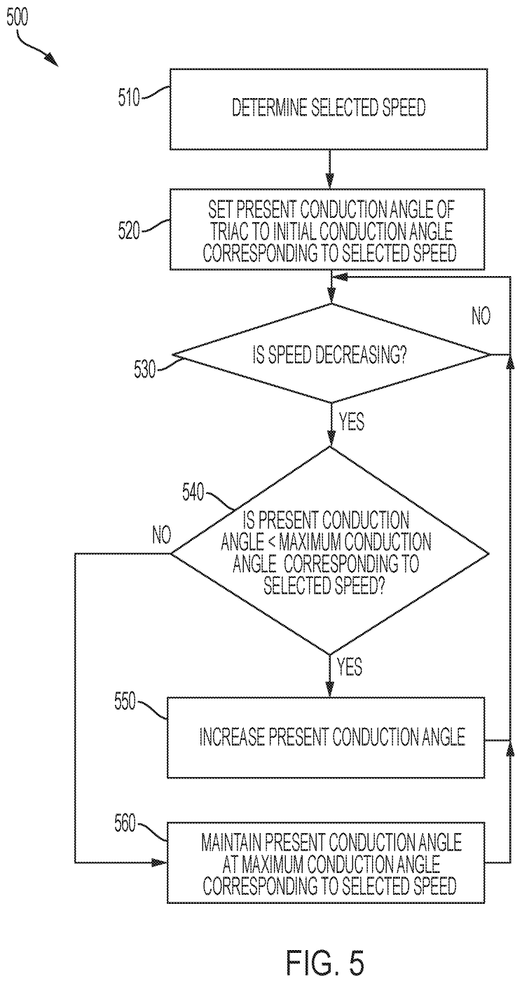

FIG. 5 is a flowchart of a method 500 for overload control in the power tool 100 in accordance with some embodiments. In the example illustrated, the method 500 includes determining, using the electronic processor 210, a selected speed (at block 510). The electronic processor 210 receives an indication of the speed selected by the user from the speed selector 150. In some embodiments, the power tool 100 may include a trigger for variable speed control and the speed selector 150 is incorporated into the trigger. A signal from the (incorporated) speed selector 150 indicating the amount to which the trigger is pulled is provided to the electronic processor 210. The electronic processor 210 determines the speed selected based on the signal received from the trigger. The indication of the speed selected from the speed selector 150 may be in the form of an analog or digital signal generated by a potentiometer, Hall-effect sensor or the like, sensing movement of the speed selector 150 (e.g., a dial or trigger), etc.

The method 500 also includes setting, using the electronic processor 210, a present conduction angle of the triac 240 to an initial conduction angle corresponding to the selected speed (at block 520). The memory 220 may store a look-up table having a mapping between a plurality of selected speeds and a plurality of initial conduction angles. The electronic processor 210 determines the initial conduction angle corresponding to the selected speed and sets the triac 240 to the initial conduction angle. The method 500 includes determining, using the electronic processor 210, whether the speed is decreasing (at block 530). The electronic processor 210 receives motor feedback indicating the speed of the motor 130 from the speed sensor 250. As discussed above, the speed of the motor 130 decreases as the load on the motor 130 increases. The electronic processor 210 determines that the speed is decreasing based on the motor feedback from the speed sensor 250. For example, to determine whether the motor speed is decreasing, the electronic processor 210 stores a recent history of one or more motor speeds sensed by the speed sensor 250, and compares a previous motor speed from the stored recent history to a current motor speed indicated by the speed sensor 250.

When the speed is decreasing, the method 500 also includes determining, using the electronic processor 210, whether the present conduction angle of the triac 240 is below a maximum conduction angle corresponding to the selected speed (at block 540). The memory 220 may store a look-up table having a mapping between a plurality of selectable speeds and a plurality of maximum conduction angles. For example, each the selectable speeds may be associated with a particular maximum conduction angle such that, for example, a first selected speed has a different maximum conduction angle than a second selected speed. In some embodiments, the lower the selected speed, the lower the maximum conduction angle. The electronic processor 210 compares the present conduction angle of the triac 240 to the maximum conduction angle for the selected speed to determine whether the present conduction angle is below the maximum conduction angle.

When the present conduction angle is below the maximum conduction angle for the selected speed, the method 500 includes increasing, using the electronic processor 210, the present conduction angle (at block 550). When the present conduction angle is at or above the maximum conduction angle, the method 500 includes maintaining the present conduction angle at the maximum conduction angle (at block 560). By cycling through blocks 530, 540, and 550, the electronic processor 210 may implement a stepwise increase of the conduction angle until the speed of the motor stabilizes to the selected speed. However, the electronic processor 210, with blocks 540 and 560, limits the conduction angle to a maximum conduction angle corresponding to the selected speed even when the load is increasing and the speed is decreasing. The method 500 repeats during operation of the tool to continuously control the conduction angle to reduce the likelihood of tool shutdown.

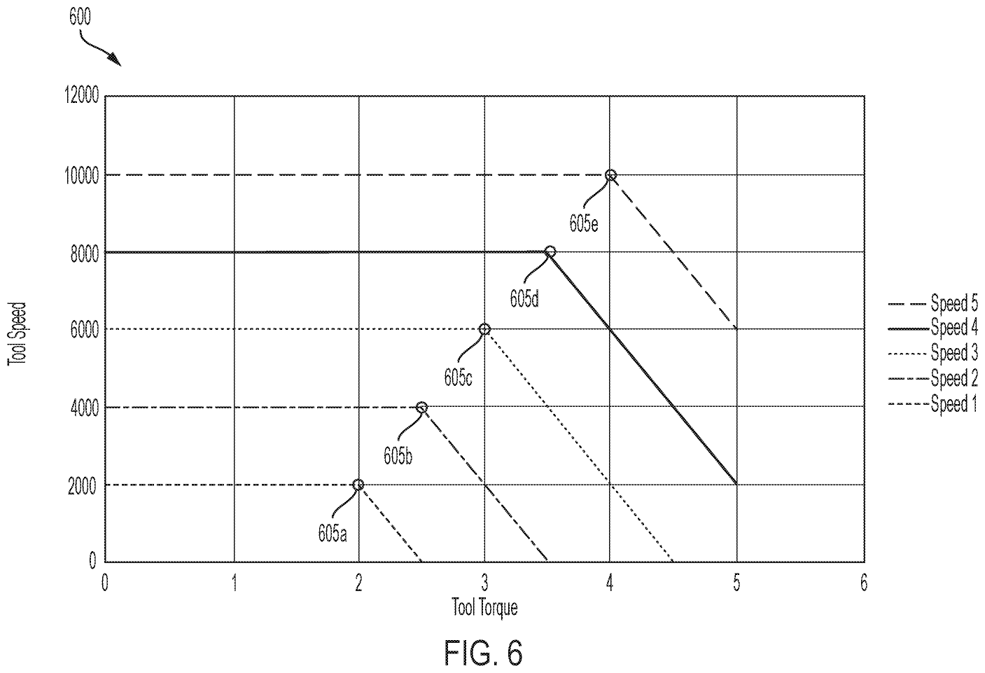

FIG. 6 is a graph 600 illustrating the effect of limiting the conduction angle as described with respect to the method 500 of FIG. 5. The graph 600 illustrates the tool output speed versus the load (tool output torque [newton-meters]) for six selectable speeds: speed 1 through speed 6. As illustrated in FIG. 6, the speed is maintained constant at each selected speed until, for speeds 1, 2, 3, and 4, at point 605a-d, the conduction angle reaches the maximum conduction angle corresponding to the selected speed. The conduction angle is not increased past the maximum conduction angle corresponding to the selected speed. Once the maximum conduction angle is reached, the motor speed decreases (as the load increases) until the tool turns off based on detecting a lock state of the motor 130 or detects an overload condition despite the limited conduction angle. In the illustrated embodiment, speed 5 does not have maximum conduction angles (or, the maximum conduction angle is 100%), because, generally, the motor speed is high enough at these speeds to generate sufficient cooling airflow with the motor-driven fan.

As described above, while embodiments are described herein with respect to AC tools and conduction angles, similar techniques apply to embodiments including a DC tool, but for the PWM duty cycle is limited, rather than a conduction angle. For example, the method of FIG. 5 similarly applies to DC tools, but for the PWM duty cycle is initially set in block 520, a present PWM duty cycle is compared to a maximum PWM duty cycle in block 540, and the PWM duty cycle is respectively increased in block 550 and maintained in block 560.

As described above with reference to FIG. 6, when the conduction angle is limited and an increased or increasing load remains present, the motor 130 continues to decrease in speed (see, e.g., the motor speed for selected speeds 1, 2, 3, and 4 after the point 605a-d in FIG. 6). In some embodiments, the limited conduction angle and decreasing speed simply continue until the motor 130 is determined to be in a locked state, at which point the electronic processor 210 stops driving the motor (e.g., the conduction angle is set to zero). For example, in a block (not shown) between blocks 520 and 530, which the electronic processor 210 loops back to executed after blocks 550 and 560, the electronic processor 210 determines the motor speed based on output from the speed sensor 250. When the electronic processor 210 determines that the motor speed has reached zero or nearly zero based on the output from the speed sensor 250 (e.g., as determined by a lack of pulses from the Hall-effect sensor for a certain amount of time), the electronic processor 210 stops driving the motor 130.

While the above techniques reduce the occurrence of overload situations by limiting conduction angle, certain situations may still give rise to an overload condition. Accordingly, in some embodiments, the tool 100 includes further overload detection and mitigation features. For example, in some embodiments, the above-described motor locked state detection and motor shutdown is a form of overload detection and mitigation. In some embodiments, other overload detection and mitigation techniques are implemented. For example, in some embodiments, during each executed loop of the blocks 520, 540, 550, and 560, the electronic processor 210 determines the current through the motor, compares the current to an overload current threshold, and determines an overload condition when the current exceeds the overload current threshold. In some embodiments, during each executed loop of the blocks 520, 540, 550, and 560, the electronic processor 210 determines the temperature within the power tool 100 using a temperature sensor, compares the temperature to an overload temperature threshold, and determines an overload condition when the temperature exceeds the overload temperature threshold.

In still other embodiments, the electronic processor 210 detects an overload condition based on a measured speed of the motor, and interrupts power to the motor 130 (e.g., shuts down the motor 130) when a cumulative value exceeds an accumulator threshold. This technique is succinctly described below; however, a more detailed description is available in U.S. patent application Ser. No. 15/378,757, filed on Dec. 14, 2016, which is herein incorporated by reference. As the motor 130 enters the overload condition, the motor speed decreases due to the increasing load on the motor 130 as described above. The electronic processor 210 therefore monitors decreases in motor speed to detect when the motor 130 is in an overload condition. The electronic processor 210 also uses a difference between the measured motor speed and a target speed to determine when to shut off the motor 130 to protect the motor 130 from damage while, at the same time, maximizing the available output power of the power tool 100. In some embodiments, the power tool 100 monitors both the motor speed, as mentioned above and described in more detail below, and the load current to detect and respond to an overload condition of the power tool 100.

When the electronic processor 210 determines that the measured speed of the motor 130 is below a target speed, the electronic processor 210 generates weighted speed data (e.g., a weighted quantity) and adds the weighted quantity to an accumulator 270 (FIG. 2). When the electronic processor 210 determines that the accumulator value reaches or exceeds the predetermined accumulator threshold, the electronic processor 210 protects the power tool 100 by interrupting power to the motor 130 to shut off the power tool 100. Being below the target speed is indicative of an overload condition and/or an increased load on the motor 130. For example, the target speed is the expected speed at the conduction angle set by the electronic processor 210. The weighted speed data is based on the difference between the measured motor speed and the target motor speed such that when the measured motor speed is only slightly below the target speed a smaller quantity is added to the accumulator 270, but when the measured motor speed is significantly below the target speed a greater quantity is added to the accumulator 270.

For example, the weighted speed data is based on a product of a multiplier and the difference between the measured speed and the target speed (i.e., the weighted speed data may correspond to the multiplier multiplied by the difference between the measured speed and the target speed). Directly measuring the motor speed deviation (i.e., the difference between the sensed motor speed and a target speed), instead of, for example, the electrical current provided to the motor 130, provides a more accurate measurement and detection of the overload condition. In some embodiments, the accumulator is decremented when the measured motor speed returns closer to the target speed. This speed-based, accumulator technique for detecting overload provides a dynamic control of the power tool 100 in an overload condition. The technique ensures that the power tool 100 is protected by applying quick shut down times when the overload on the power tool 100 is significant (by adding a larger quantity to the accumulator when speed is significantly below target), and that the power tool 100 provides improved power output and usability for the user (by reducing overly-sensitive overload detection).

Thus, various embodiments described herein provide for avoiding, detecting, and mitigating an overload condition on a power tool. Various features and advantages are set forth in the following claims.

What is claimed is:

1. A power tool comprising:
a housing;
a motor within the housing;
a power circuit supplying operating power to the motor through a triac;
a speed sensor configured to detect a speed of the motor;
a speed selector; and
an electronic processor electrically coupled to the motor, the triac, the speed sensor, and the speed selector and configured to
determine, from the speed selector, a selected speed,
set a present conduction angle of the triac to an initial conduction angle corresponding to the selected speed,
determine whether the speed is decreasing,
determine whether the present conduction angle is below a maximum conduction angle corresponding to the selected speed when the speed is decreasing,
increase the present conduction angle when the present conduction angle is below the maximum conduction angle corresponding to the selected speed, and
maintain the present conduction angle at the maximum conduction angle corresponding to the selected speed when the present conduction angle is at or above the maximum conduction angle.

2. The power tool of claim 1 further comprising a power cord attached to the housing to receive AC power.

3. The power tool of claim 1, further comprising a tool bit, wherein the speed decreases due to interaction of the tool bit with a work-piece.

4. The power tool of claim 1, wherein the speed is increased to maintain the selected speed.

5. The power tool of claim 1, further comprising one of a temperature sensor and a temperature estimator to provide a temperature indication to the electronic processor, wherein the electronic processor is further configured to
turn off the motor when the temperature indication indicates that a temperature of the power tool is above a predetermined temperature threshold.

6. The power tool of claim 1, wherein the electronic processor is further configured to determine a motor current; and
turn off the motor when the motor current exceeds an overload current threshold.

7. The power tool of claim 1, further comprising a fan coupled to and rotating with an output shaft of the motor and is configured to provide cooling airflow to the motor and other components of the power tool.

8. The power tool of claim 1, further comprising a memory storing a look-up table having a mapping between a plurality of selectable speeds and a plurality of initial conduction angles and a plurality of maximum conduction angles, wherein a first maximum conduction angle corresponding to a first selectable speed of the plurality of selectable speeds is lower than a second maximum conduction angle corresponding to a second selectable speed of the plurality of selectable speeds.

9. The power tool of claim 1, wherein the electronic processor is configured to implement a stepwise increase of the present conduction angle until the motor speed stabilizes to the selected speed while limiting the present conduction angle to the maximum conduction angle corresponding to the selected speed even when a load is increasing and the speed is decreasing.

10. The power tool of claim 9, wherein once the maximum conduction angle is reached, the speed decreases until the power tool is turned off based on detecting a lock state of the motor.

11. A method for overload control of a power tool, the method comprising:
determining, using an electronic processor, a selected speed of the power tool;
setting, using the electronic processor, a present conduction angle of a triac of the power tool to an initial conduction angle corresponding to the selected speed;
detecting, using a speed sensor, a speed of a motor of the power tool
determining, using the electronic processor, whether the speed is decreasing;
determining, using the electronic processor, whether the present conduction angle is below a maximum conduction angle corresponding to the selected speed when the speed is decreasing;
increasing, using the electronic processor, the present conduction angle when the present conduction angle is below the maximum conduction angle corresponding to the selected speed; and
maintaining, using the electronic processor, the present conduction angle at the maximum conduction angle corresponding to the selected speed when the present conduction angle is at or above the maximum conduction angle.

12. The method of claim 11, further comprising receiving, using a power cord attached to a housing of the power tool, AC power.

13. The method of claim 11, wherein the speed decreases due to interaction of a tool bit of the power tool with a work-piece.

14. The method of claim 11, wherein the speed is increased to maintain the selected speed.

15. The method of claim 11, further comprising:
determining, using one of a temperature sensor and a temperature estimator, a temperature of the power tool; and
turning off the motor when the temperature of the power tool is above a predetermined temperature threshold.

16. The method of claim 11, further comprising:
determining a motor current; and
turning off the motor when the motor current exceeds an overload current threshold.

17. The method of claim 11, further comprising providing, using a fan coupled to and rotating with an output shaft of the motor, cooling airflow to the motor and other components of the power tool.

18. The method of claim 11, further comprising storing, using a memory, a look-up table having a mapping between a plurality of selectable speeds and a plurality of initial conduction angles and a plurality of maximum conduction angles, wherein a first maximum conduction angle corresponding to a first selectable speed of the plurality of selectable speeds is lower than a second maximum conduction angle corresponding to a second selectable speed of the plurality of selectable speeds.

19. The method of claim 11, further comprising implementing, using the electronic processor, a stepwise increase of the present conduction angle until the motor speed stabilizes to the selected speed while limiting the present conduction angle to the maximum conduction angle corresponding to the selected speed even when a load is increasing and the speed is decreasing.

20. The method of claim 19, wherein once the maximum conduction angle is reached, the speed decreases until the power tool is turned off based on detecting a lock state of the motor.
